(19) United States
(12) Patent Application Publication
(10) Pub. No.: US 2010/0034083 A1
(43) Pub. Date: Feb. 11, 2010

(54) METHOD AND APPARATUS FOR PACKET DIFFERENTIATION IN A WIRELESS COMMUNICATION SYSTEM

(75) Inventors: Rajat Prakash, La Jolla, CA (US); Parag A. Agashe, San Diego, CA (US); Kalle Ahmavaara, San Diego, CA (US); Gerardo Giaretta, San Diego, CA (US); Osok Song, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/536,597

(22) Filed: Aug. 6, 2009

Related U.S. Application Data
(60) Provisional application No. 61/087,588, filed on Aug. 8, 2008.

(51) Int. Cl. H04L 12/26

(52) U.S. Cl. 370/230.1

(57) ABSTRACT

Systems and methodologies are described herein that facilitate efficient packet differentiation and forwarding in a wireless communication system. As described herein, identifiers or tags (e.g., corresponding to radio bearers, logical channels, Internet Protocol (IP) addresses, etc.) can be applied to respective packets based on their destinations as determined by traffic flow templates (TFTs) associated with the packets. Further, techniques are provided for establishing radio bearers, IP addresses, and/or other resources for transmission of packets associated with respective TFTs in a manner irrespective of associated quality of service (QoS) policies for the TFTs. Upon an establishment of resources, techniques are described herein for tagging packets with resources associated with TFTs corresponding to the packets to facilitate forwarding of respective packets to their intended destinations with lowered required processing cost. Additionally, techniques are described herein for offloading packet analysis and/or forwarding functionality from a terminal to a device tethered to the terminal.

### CROSS-REFERENCE

This application claims the benefit of U.S. Provisional Application Ser. No. 61/087,588, filed Aug. 8, 2008, and entitled “Methods and Apparatuses to Separate a First Type of Packet from a Second Type of Packet,” the entirety of which is incorporated herein by reference.

### BACKGROUND

I. Field

The present disclosure relates generally to wireless communications, and more specifically to techniques for directing data communicated within a wireless communication system.

II. Background

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, and Orthogonal Frequency Division Multiple Access (OFDMA) systems.

Generally, a wireless multiple-access communication system can simultaneously support communication for multiple wireless terminals. In such a system, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out (SISO), multiple-in-signal-out (MISO), or a multiple-in-multiple-out (MIMO) system.

In various wireless communication implementations, a shared or “split” communication scheme can be employed, wherein a user equipment unit (UE) and/or another device operable to communicate with a wireless communication network shares connectivity with one or more other devices. In such a case, information such as data, control signaling, or the like can be communicated to the UE device and/or any devices utilizing the connectivity of the UE device in the form of respective packets and/or other suitable units. Such packets can relate to both control applications and/or other applications hosted at the UE device as well as “end user” applications hosted at respective devices that share the connectivity of the UE device.

In one example, a UE can be configured to identify control application datagrams or packets such that they can be consumed locally by the UE as well as to deliver end user application datagrams to respectively associated external devices. Conventionally, a UE can accomplish this by filtering substantially all downlink packet traffic and routing respective packet flows to an internal data sink and/or respective external devices based on the downlink filtering. However, it can be appreciated that filtering and routing as performed in this manner requires port and/or protocol number-based packet filtering across substantially all downlink bearers, which can be prohibitively complex in the case of a high data rate network and/or other implementations. Accordingly, it would be desirable to implement techniques for packet filtering and/or routing that mitigate at least the above shortcomings.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

According to an aspect, a method is described herein. The method can comprise identifying traffic flow templates (TFTs) associated with respective packet destinations in a set of packet destinations; generating one or more filtering rules that facilitate application of identifiers to respective packets based on destinations of the respective packets as determined based on TFTs applied to the respective packets; and communicating the one or more filtering rules to a packet processing entity

A second aspect described herein relates to a wireless communications apparatus, which can comprise a memory that stores data relating to TFTs associated with at least one of the wireless communications apparatus or one or more tethered devices. The wireless communications apparatus can further comprise a processor configured to generate filtering rules that facilitate application of tags to respective packets based on destinations of the respective packets as determined based on TFTs associated with the respective packets and to communicate one or more filtering rules to a packet processing entity.

A third aspect relates to an apparatus, which can comprise means for identifying associations between respective TFTs and a set of packet destination devices comprising the apparatus and at least one device tethered to the apparatus and means for constructing respective rules that facilitate application of identifiers to respective communicated packets that indicate destination devices of the respective communicated packets based on TFTs associated with the respective communicated packets.

A fourth aspect described herein relates to a computer program product, which can include a computer-readable medium that comprises code for causing a computer to identify associations between respective TFTs and a set of packet destinations comprising a local device and at least one device tethered to the local device and code for causing a computer to construct respective rules that facilitate application of identifiers to respective communicated packets that indicate packet destinations respectively corresponding to the communicated packets based on TFTs associated with the respective communicated packets.

A fifth aspect described herein relates to a method operable in a wireless communication system. The method can comprise receiving a request for association of one or more TFTs with respective user equipment (UE) radio bearers or terminal equipment (TE) radio bearers and mapping the one or more TFTs to respective UE radio bearers or TE radio bearers based on the request irrespective of quality of service (QoS) policies associated with the one or more TFTs.

A sixth aspect described herein relates to a wireless communications apparatus, which can comprise a memory that stores data relating to one or more TFTs requested for association with respective UE radio bearers or TE radio bearers. The wireless communications apparatus can further include a processor configured to map the one or more TFTs to respective UE radio bearers or TE radio bearers irrespective of QoS policies associated with the one or more TFTs.

A seventh aspect relates to an apparatus, which can comprise means for identifying a request to associate one or more TFTs with respective radio bearers and means for associating respective TFTs provided in the request to respective radio bearers independently of signal quality policies associated with the respective TFTs.

An eighth aspect described herein relates to a computer program product, which can include a computer-readable medium that comprises code for causing a computer to identify a request to associate one or more TFTs with respective radio bearers and code for causing a computer to associate respective TFTs provided in the request to respective radio bearers irrespective of signal quality policies associated with the respective TFTs.

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter can be employed. Further, the disclosed aspects are intended to include all such aspects and their equivalents.

### BRIEF DESCRIPTION OF THE DRAWINGS

FIG. 1 is a block diagram of a system for routing data between a wireless communication network, an associated user equipment unit, and respective tethered devices in accordance with various aspects.

FIG. 2 is a block diagram of a system for initializing filtering rules for packet differentiation in accordance with various aspects.

FIG. 3 is a block diagram of a system for utilizing a set of radio bearers for packet differentiation and forwarding in accordance with various aspects.

FIGS. 4-5 are diagrams that illustrate respective techniques for initializing radio bearers for packet routing in accordance with various aspects.

FIGS. 6-7 illustrate example message structures that can be utilized in the context of a radio bearer setup procedure in accordance with various aspects.

FIG. 8 is a diagram that illustrates a further example technique for initializing radio bearers for packet routing in accordance with various aspects.

FIG. 9 is a block diagram of a system for utilizing a set of Internet Protocol addresses for packet differentiation and forwarding in accordance with various aspects.

FIG. 10 is a diagram that illustrates an example technique for initializing Internet Protocol addresses for packet routing in accordance with various aspects.

FIG. 11 is a block diagram of a system for configuring a tethered device for packet forwarding in accordance with various aspects.

FIGS. 12-14 are flow diagrams of respective methodologies for configuring efficient packet differentiation and forwarding in a wireless communication system.

FIG. 15 is a flow diagram of a methodology for processing a received packet according to a preconfigured set of filtering rules.

FIG. 16 is a flow diagram of a methodology for establishing respective radio bearers for transmission of packets to multiple packet destinations.

FIGS. 17-18 are block diagrams of respective systems that facilitate packet differentiation and forwarding in a wireless communication system.

FIG. 19 illustrates a wireless multiple-access communication system in accordance with various aspects set forth herein.

FIG. 20 is a block diagram illustrating an example wireless communication system in which various aspects described herein can function.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2).

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

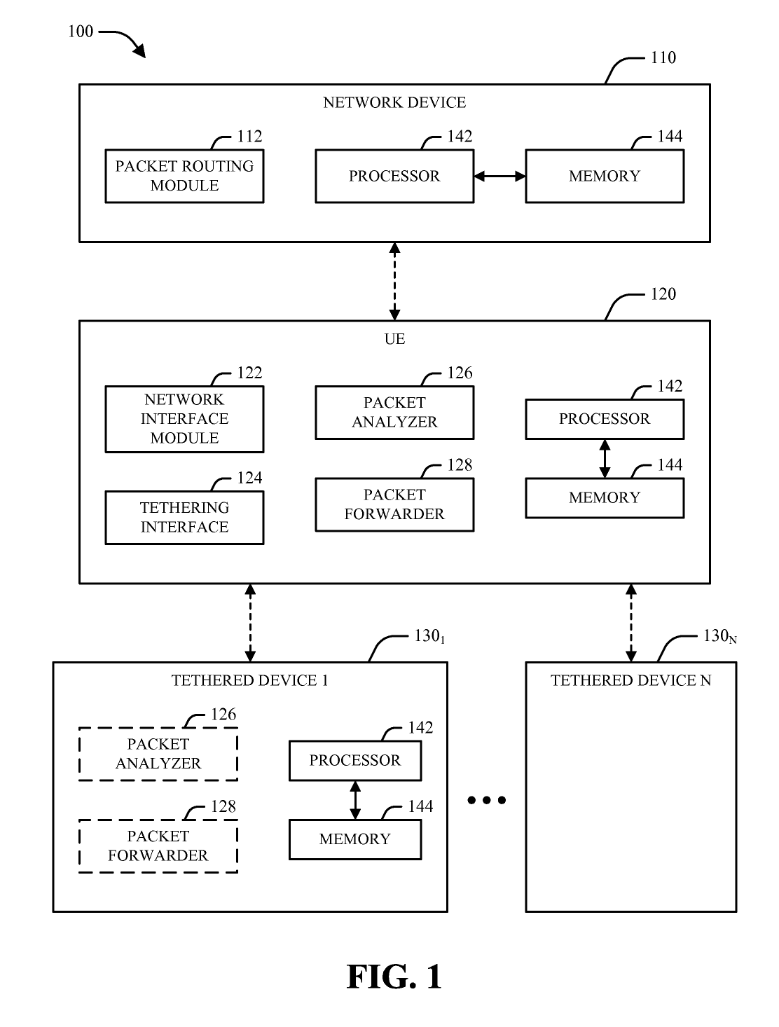

Referring now to the drawings, FIG. 1 illustrates a system 100 for routing data between a wireless communication network (e.g., associated with a network device 110), an associated user equipment unit (UE) 120, and respective tethered devices 130 in accordance with various aspects described herein. As illustrated by system 100, a network device or element 110 can correspond to any suitable entity or entities associated with a wireless communication network, such as an Evolved UMTS (Universal Mobile Telecommunications System) Terrestrial Radio Access Network (E-UTRAN) or a portion thereof (e.g., cell, sector, etc.), that can be utilized for providing data communication functionality to respective devices in system 100. Network device 110 can be and/or implement the functionality of, for example, a Node B or Evolved Node B (eNB, also referred to herein as a base station, access point (AP), etc.), a network gateway entity, a system controller, or the like. In one example, network device 110 can engage in one or more downlink (DL, also referred to as forward link (FL)) communications with UE 120 (also referred to herein as an access terminal (AT), mobile terminal, user station or device, etc.), and UE 120 can engage in one or more uplink (UL, also referred to as reverse link (RL)) communications with network device 110.

In accordance with one aspect, UE 120 can be utilized to provide network connectivity for one or more tethered devices 130 associated with UE 120. Tethered devices 130 can include, for example, computers such as desktop, laptop, and/or tablet computers; personal digital assistants (PDAs); smartphones; and/or any other suitable device. In one example, UE 120 can be connectively coupled to network device 110 via a network interface module 122 and/or other suitable means and to respective tethered devices 130 by way of a tethering interface 124. It can be appreciated that tethering interface 124 can facilitate tethering between UE 120 and tethered devices 130 using any suitable connection type(s), such as a Personal Computer Memory Card International Association (PCMCIA) connection, a universal serial bus (USB) connection, a Bluetooth and/or other suitable wireless personal area network (WPAN) connection, a Wi-Fi (e.g., IEEE 802.11) connection, and/or any other suitable connection modality or modalities. Further, it can be appreciated that UE 120 can be associated with and/or implemented by any suitable device(s) or device component(s), such as a mobile telephone handset, a modem chipset, a standalone network adapter, or the like. In another example, UE 120 can utilize techniques for Internet Connection Sharing (ICS) or the like as described herein and/or generally known in the art to provide connectivity between respective tethered devices 120 and the Internet via network device 110.

As described above, UE 120 can be implemented as a shared or split UE in order to share connectivity to network device 110 with respective tethered devices 130 via tethering interface 124. In such an example, UE 120 can be configured to communicate information relating “end user” applications or clients hosted at the Internet Protocol (IP) stack of one or more tethered devices 130 as well as “control application” clients hosted at an IP stack associated with UE 120 itself. Examples of control applications for which UE 120 can locally consume information include dynamic host configuration protocol (DHCP) applications, position location applications (e.g., secure user plane location (SUPL), etc.), self-organized network (SON) operations for which packets arrive on the user plane, Mobile IP (MIP) and/or reservation protocol (RSVP) applications, or the like.

In one example, a packet routing module 112 and/or another suitable mechanism at network device 110 can be configured to communicate respective datagrams or packets on the downlink to UE 120 that relate both to control applications utilized by UE 120 and end user applications utilized by respective tethered devices 130. Subsequently, a packet analyzer 126 at UE 120 can identify and distinguish between control application downlink IP datagrams and end user application IP datagrams. In one example, this analysis can be based on respective traffic flow templates (TFTs) and/or other information associated with respective datagrams or packets. More particularly, a TFT can be utilized in the context of a datagram or packet to identify parts of the Transmission Control Protocol (TCP)/IP header of the packet and/or one or more other fields that identify the packet as associated with either UE 120 or tethered device 130. In one example, TFTs can be implementation dependent at UE 120 as a function of applications that execute at UE 120 and/or other suitable factors. In another example, based on TFTs and/or other information associated with respective packets, packet analyzer 126 can attempt to identify patterns in the respective packets that match one or more TFTs corresponding to destinations of the respective packets. Based on this analysis, a packet forwarder 128 can be utilized by UE 120 to facilitate local consumption of the control application IP datagrams and/or to deliver respective end user application IP datagrams to the appropriate tethered device(s) 130.

Using existing packet analysis techniques, packet analyzer 126 can achieve the above ends by filtering substantially all downlink IP traffic and, based on the downlink filtering, instructing packet forwarder 128 to route the corresponding IP flows to the IP stack of UE 120 and/or to respective tethered devices 130. However, it can be appreciated that filtering based on existing packet analysis techniques as described above can require packet analyzer 126 to analyze each packet that arrives from network device 110. For example, port and/or protocol number-based packet filtering may be required across substantially all downlink bearers in some cases, which can significantly increase operational complexity in the case of a high data rate network and/or other network implementations. This increase in complexity can result in increased processing overhead, reduced UE and/or network throughput, and/or other negative effects on the performance of system 100. Further, while a specialized hardware engine can be utilized to perform some and/or all packet analysis and/or routing, it can be appreciated that such an implementation necessitates an undesirable increase in UE complexity, manufacturing costs, and the like.

In accordance with one aspect, system 100 can mitigate at least the shortcomings of existing packet differentiation and routing techniques described above by facilitating the application of distinct identifiers to respective packets communicated within system 100 based on an intended destination of the respective packets. In one example, identifiers applied to respective packets can correspond to distinct radio bearers, logical channels, IP addresses, or the like, on which respective packets are communicated based on destination. By way of example, separate bearers can be provided by network device 110 for control application traffic destined for UE 120 and end user traffic destined for a tethered device 130, thereby allowing UE 120 to efficiently distinguish between the two types of packet traffic and forward said traffic to its appropriate destinations. Further, by utilizing distinct bearers, channels, IP addresses, or the like in this manner, it can be appreciated that packet differentiation complexity can be shifted to network device 110 such that UE 120 can process and/or forward respective packets without being required to examine the protocol or port fields of the bulk packets that are consumed by tethered device(s) 130. Techniques by which communication of respective packets in this manner can be initialized and/or used are described in further detail herein.

In accordance with an additional aspect, UE 120 can be enabled to offload some or all functionality of packet analyzer 126 and/or packet forwarder 128 to one or more tethered devices 130. For example, UE 120 can initially be configured to forward all packets to a tethered device 130 irrespective of destination, such that the tethered device 130 can analyze the respective packets, determine their respective intended destinations, and forward respective packets destined for UE 120 back to UE 120. Techniques for offloading packet processing and/or forwarding in this manner are additionally described in further detail herein. In accordance with a further aspect, a processor 142 and/or a memory can be utilized by one or more of network device 110, UE 120, or tethered device(s) 130 to implement some or all of the functionality described herein and/or any other suitable functionality.

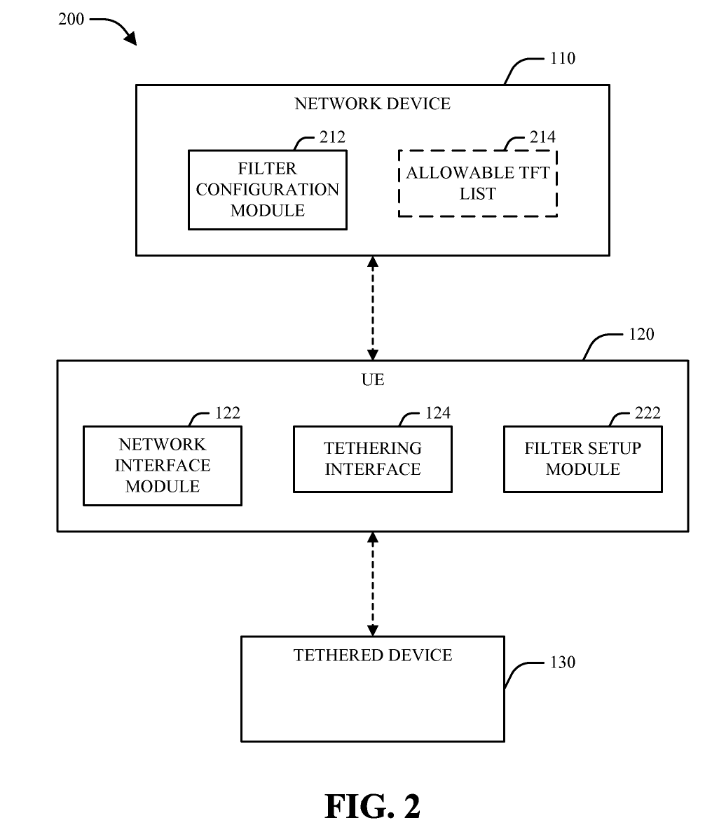

Turning next to FIG. 2, a system 200 for initializing filtering rules for packet differentiation in accordance with various aspects is illustrated. In a similar manner to that described above with respect to system 100, system 200 can include a UE 120 that is operable to communicate with a network device 110 via a network interface module 122 and one or more tethered devices 130 via a tethering interface 124. In accordance with one aspect, UE 120 can include a filter setup module 222, which can generate and/or otherwise identify filtering rules to be applied by a filter configuration module 212 at network device 110, thereby shifting the burden of packet differentiation from UE 120 to network device 110 and reducing the required complexity of network device 110.

In one example, filter setup module 222 can generate and/or otherwise identify filtering rules based on associations between respective TFTs utilized by system 200 and packet destinations (e.g., UE 120 or tethered device 130) that correspond to the respective TFTs. Filtering rules utilized by filter setup module 222 can, for example, be utilized to facilitate the application of respective identifiers or tags to packets transmitted by network device 110 based on TFTs associated with the respective packets. Tags applied to respective packets can be, for example, logical channel identifiers and/or identifiers associated with any other suitable protocol layer (e.g., physical (PHY) layer, medium access control (MAC) layer, radio link control (RLC) layer, etc.). Based on such filtering rules, filter configuration module 212 at network device 110 can utilize a first set of identifiers for packets destined for UE 120 and a second, distinct set of identifiers for packets destined for a tethered device 130, thereby enabling UE 120 to efficiently and readily identify the intended destination of a given packet by examining only the identifier applied to the packet.

In accordance with one aspect, network device 110 can be configured to accept and apply filtering rules from UE 120 that request association between TFTs and respective tag values in substantially all cases irrespective of any quality of service (QoS) policies associated with system 200 and/or the TFTs given in the filtering rules. Alternatively, network device 110 can be equipped with an allowable TFT list 214 that specifies a predefined set of TFTs for which filtering rules are applied irrespective of QoS policies. In the event that an allowable TFT list 214 is employed by network device 110, filtering rules that specify TFTs not included in allowable TFT list 214 can be denied, selectively accepted based on QoS policies associated with the TFTs, and/or processed in any other suitable manner.

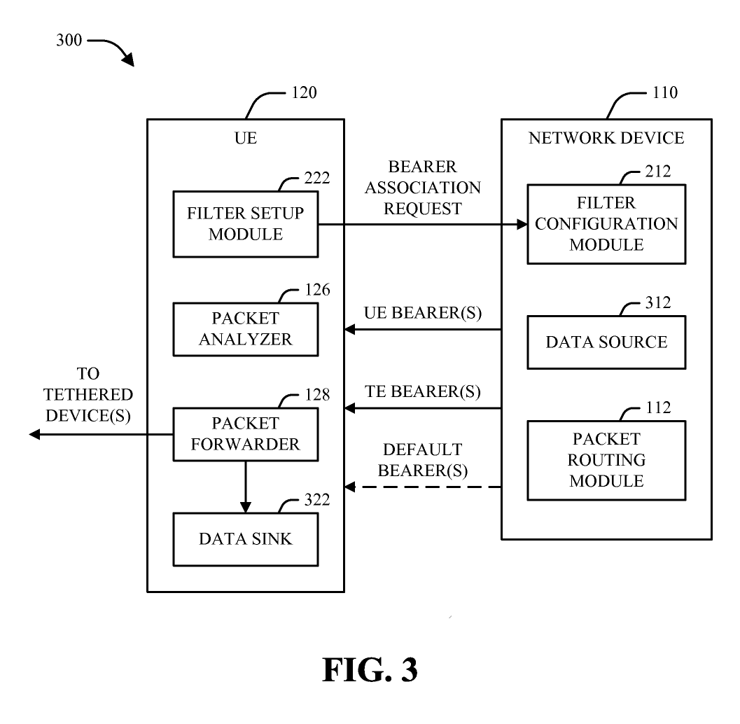

By way of example, UE 120 can facilitate the association of TFTs to respective radio bearers as a function of packet destination. This is illustrated by system 300 in FIG. 3. As system 300 illustrates, a filter setup module 222 at a UE 120 can initiate a request procedure with a network device 110 in which a bearer association request and/or another suitable set of information is communicated to a filter configuration module 212 at network device 110. In one example, a bearer association request can indicate TFT labels that are to be associated with respective radio bearers. These radio bearers can include one or more UE bearers and/or one or more terminal equipment (TE) bearers, such that TFT labels associated with traffic to UE 120 can be associated with one or more UE bearers and TFT labels associated with traffic to one or more TE devices (not shown) tethered to UE 120 can be associated with one or more TE bearers. Accordingly, data transmitted by network device 110 (e.g., via a data source 312) can be analyzed by a packet analyzer 126 at UE 120 upon receipt by determining a radio bearer on which the data were transmitted without requiring packet analyzer 126 to examine respective data packets to determine their intended destinations. Subsequently, based on the radio bearers on which data are sent as determined by packet analyzer 126, a packet forwarder 128 can provide respective packets to a data sink 322 locally associated with UE 120 and/or to one or more tethered TE devices.

In accordance with one aspect, network device 110 and UE 120 can be configured to utilize one or more default bearers in addition to UE bearers and/or TE bearers, such that respective packets associated with a TFT for which filtering rules have not been supplied by UE 120 can be transmitted by network device 110 to UE 120 over one or more default bearers. Upon receiving data on a default bearer, packet analyzer 126 can examine respective packets to determine an intended destination for the packets in accordance with one or more techniques as generally known in the art prior to facilitating forwarding of the packets via packet forwarder 128.

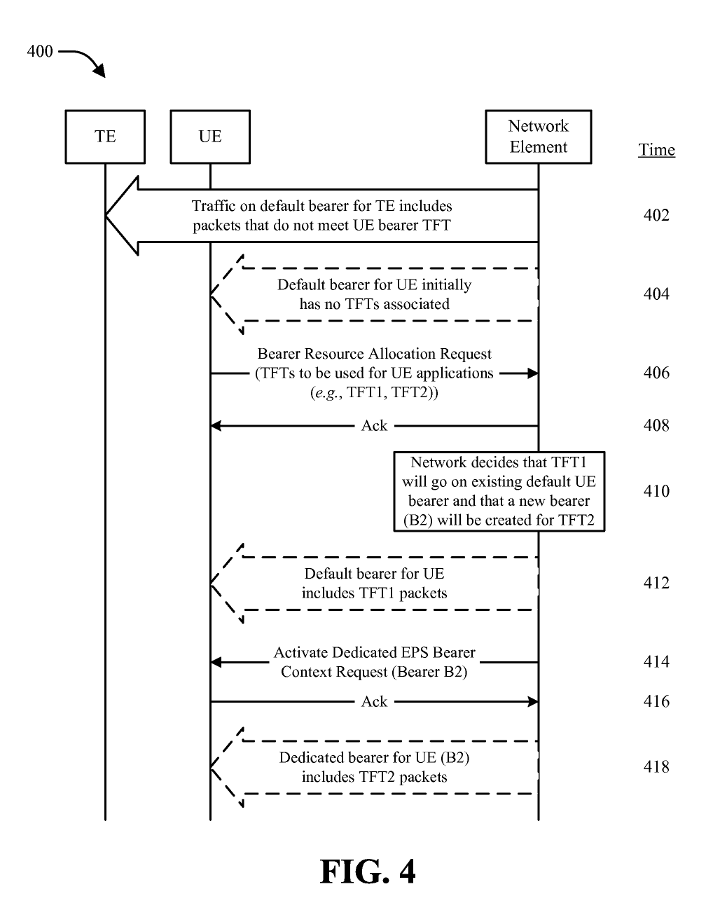

In accordance with another aspect, network device 110 and UE 120 can be operable to set up and utilize respective radio bearers for packet communication as described above in a variety of manners. By way of a first example, two default bearers (e.g., one default UE bearer and one default TE bearer) can be pre-established and utilized for each packet data protocol (PDP) context as illustrated in diagram 400 in FIG. 4. As diagram 400 illustrates, a default TE bearer can be preconfigured at time 402 to include traffic corresponding to packets that do not meet one or more UE bearer TFTs. Similarly, a default UE bearer can be preconfigured at time 404 to initially have no associated TFTs.

Subsequently, at time 406, the UE can submit a Bearer Resource Allocation Request message to an associated network element that specifies TFTs to be utilized for UE applications. In the example shown in diagram 400, TFT1 and TFT2 are specified. The network element can then provide an acknowledgement (Ack) of this message at time 408. At time 410, the network can act on the bearer request submitted at time 406 by configuring one or more UE bearers to carry the specified TFTs. For example, as shown in diagram 400, the network decides at time 410 that TFT1 will be transmitted on the existing default UE bearer and that a new bearer (e.g., B2) will be created for TFT2. It should be appreciated, however, that the network could similarly place TFTs on the default bearer and/or any number of new created bearers at time 410 in any suitable manner.

According to the decisions made by the network at time 410, the default UE bearer can be configured at time 412 to include packets associated with TFT1. In addition, the network element can establish new bearer B2 by submitting an Activate Dedicated EPS (Evolved Packet System) Bearer Context Request message at time 414 that specifies the identity of bearer B2, which can be acknowledged by the UE at time 416. Upon establishment of bearer B2, bearer B2 can be configured to include packets associated with TFT2 at time 418.

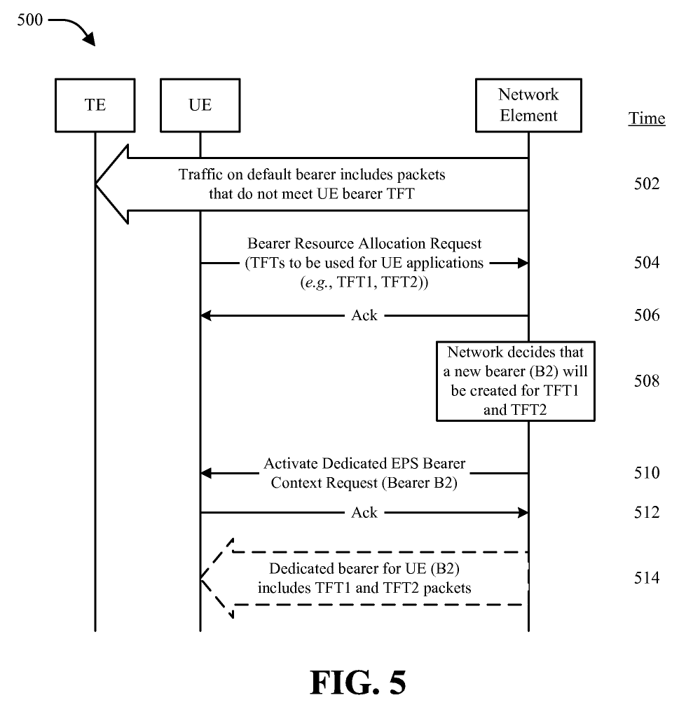

By way of a second example, UE 120 can request separate bearers for respective TFTs and a generalized default bearer can be pre-established and utilized as shown in diagram 500 in FIG. 5. As diagram 500 illustrates, a default bearer can be established at time 502, which can be associated with packets that do not match any established UE bearer TFTs. At times 502-504, a Bearer Resource Allocation Request for respective TFTs to be associated with UE applications can be submitted to and acknowledged by a serving network element for a UE in a similar manner to that described above with respect to times 406-408 as illustrated in diagram 400. Next, at time 508, the network can determine one or more new bearers (e.g., bearer B2) to be created in response to the UE's request. Based on the network's decision, respective UE bearers can be established at times 510-512 in a similar manner to that described above with respect to times 414-416 in diagram 400, at which point a created bearer B2 can be configured to include packets associated with respective UE application TFTs (e.g., TFT 1 and TFT2) at time 514. With regard to diagram 500, it should be appreciated that while diagram 500 illustrates the creation of a new UE bearer B2 in response to a bearer allocation request from a UE, similar techniques to that illustrated by diagram 500 could be utilized for the establishment of TE bearers and/or any other suitable type(s) of bearers.

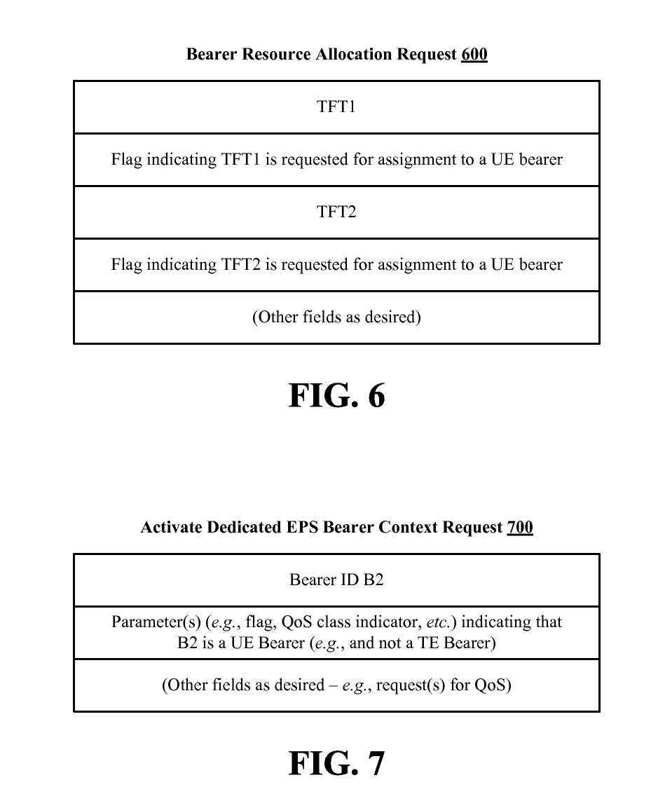

In accordance with one aspect, examples of structures that can be utilized for respective message types communicated as shown in diagrams 400-500 are illustrated in further detail by message structure 600 in FIG. 6 and message structure 700 in FIG. 7. More particularly, message structure 600 illustrates an example structure of a Bearer Resource Allocation Request message, which can be communicated by a UE to a serving network to request allocation of a dedicated bearer resource. Additionally or alternatively, message structure 700 illustrates an example structure of an Activate Dedicated EPS Bearer Context Request message, which can be communicated by a network element to an associated UE to request activation of a dedicated EPS bearer context associated with the same packet data network (PDN) addresses and/or access point name (APN) as an already active default EPS bearer context.

In accordance with another aspect, a non-default bearer utilized by respective devices in a wireless communication system can be tagged as a UE bearer or a TE bearer. Further, the status of a given bearer as a UE bearer or TE bearer can be signaled using non-access stratum (NAS) signaling at the time the bearer is initialized. By way of a first specific example, message structure 600 can be utilized by a UE to denote a desired bearer as a UE bearer at the time the bearer is requested. Thus, as shown by message structure 600, a Bearer Resource Allocation Request message can include filters for identities of respective TFTs and corresponding flags and/or other indications that said TFTs are requested for assignment to a UE bearer. Flags and/or other indications provided within message structure 600 corresponding to respective filters can include, for example, a UE_Bearer_Requested bit and/or another suitable indicator that can be set to indicate to the serving network that corresponding filters are to be attached to a bearer designated as a UE bearer. Alternatively, a UE can utilize a predetermined QoS class indicator (QCI) parameter reserved for indication of a UE bearer in a bearer allocation request such that an associated network can be configured to accept filters relating to the reserved QCI parameter and place corresponding filtered traffic on respective control application or UE bearers.

By way of another specific example, message structure 700 can be utilized by a network element to denote an allocated bearer as a UE bearer. More particularly, as shown by message structure 700, an Activate Dedicated EPS Bearer Context Request message can include one or more identifiers of established bearers along with respective parameters that indicate the respective identified bearers as UE bearers. Parameters utilized to indicate a bearer as a UE bearer can include, for example, a flag parameter (e.g., a flag similar to the UE_Bearer_Requested bit as described above), a predetermined QCI parameter reserved for indication of a UE bearer, or the like. In one example, a reserved QCI parameter provided as part of message structures 600 and/or 700 can be configured not to relay strict QoS properties. Instead, in one example UE bearers utilized by an associated wireless communication system can be configured with default QoS properties, such that a network can utilize the default QoS properties or provide superior QoS policies.

By way of a third example operating technique that can be utilized by system 300, UE 120 and network device 110 can be configured to establish respective UE bearers, TE bearers, or the like at the time of PDN context creation. In one example, a UE and an associated network element can perform one or more initial procedures for establishing a PDN connection between the UE and network element at the time of PDN context creation. For example, a UE can indicate respective protocol configuration options (PCO or “PCO options”) to be utilized for respective initial packets to be transmitted to the network, such as Dynamic Host Configuration Protocol (DHCP) options, procedures for establishing IP and/or Domain Name System (DNS) addresses, or the like.

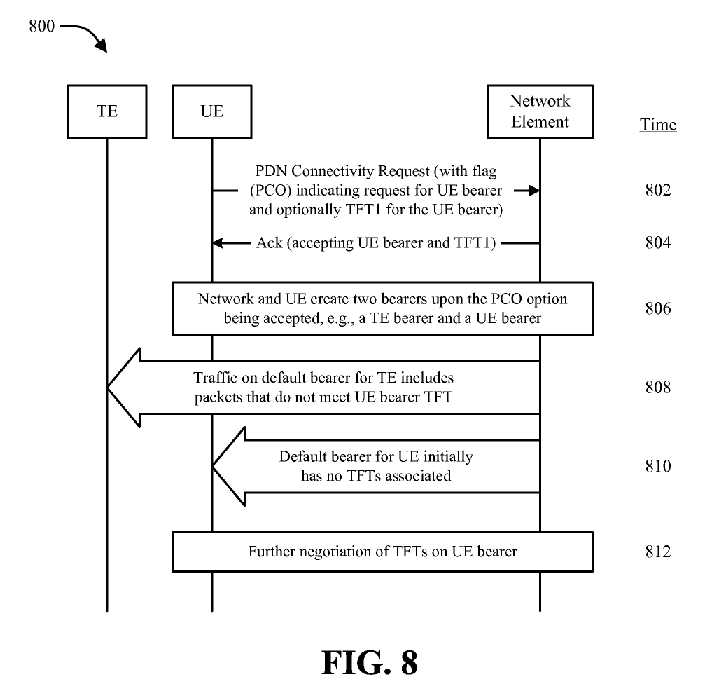

In accordance with one aspect, PCO options communicated by a UE during PDN context creation can include a request for respective dedicated UE and/or TE bearers. This is illustrated by diagram 800 in FIG. 8. As diagram 800 illustrates, a UE can initially submit a PDN Connectivity Request message to an associated network element for establishing a PDN connection with the network element at time 802. The message can include a flag and/or another suitable PCO indicator that indicates a request for a UE bearer and (optionally) respective TFTs (e.g., TFT 1) for the UE bearer. At time 804, the network can respond to the message with an acknowledgement that indicates acceptance of the UE bearer and TFT 1 (if provided). Upon acceptance of the PCO option, the network and UE can create a default UE bearer and a default TE bearer at time 806. Thus, a default TE bearer can be configured at time 808 to include packets that do not match UE bearer TFTs, and a default UE bearer can be configured at time 810 to initially have no packets associated therewith. Upon configuration of the bearers at times 808-810, further negotiation of TFTs to be associated with respective bearers can occur at time 812 in accordance with respective techniques as described herein.

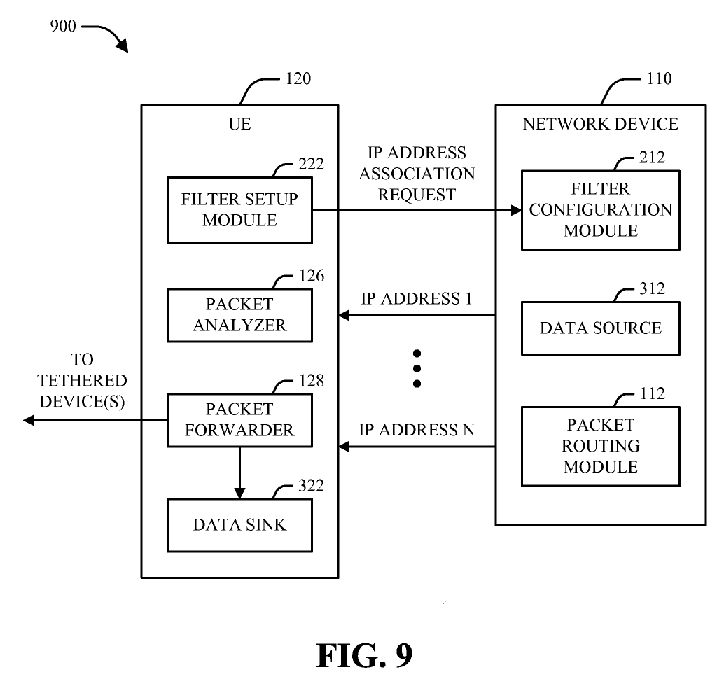

Referring next to FIG. 9, a block diagram of a system 900 for utilizing a set of Internet Protocol addresses for packet differentiation and forwarding in accordance with various aspects is illustrated. In a similar manner to system 300 in FIG. 3, system 900 can include a UE 120 that can utilize a filter setup module to communicate requests for TFT filtering to a filter configuration module 212 at an associated network device 110. As system 900 further illustrates, filter setup module 222 can be configured to supply an IP address association request to network device 110 that facilitates association of TFTs associated with respective packet destinations to distinct IP addresses. Based on a communicated IP address association request, a packet routing module 112 can communicate packets and/or other information (e.g., as obtained from data source 312) to UE 120 via a set of IP addresses. In one example, filters can be set up between UE 120 and network device 110 such that respective IP addresses correspond to respective packet destinations, such that a packet analyzer can determine an intended destination of a given packet by examining the IP address associated with the packet and facilitate forwarding of the packet via a packet forwarder 128 to a local data sink 322 and/or one or more tethered devices (not shown).

In accordance with one aspect, UE 120 can be enabled to support communication of respective packets over multiple IP addresses by establishing multiple respective PDP contexts to a common packet gateway (PGW) and/or another suitable element or elements of network device 110. Further, IP addresses utilized for communication between network device 110 and UE 120 can be implemented using a single, shared radio bearer and/or multiple radio bearers.

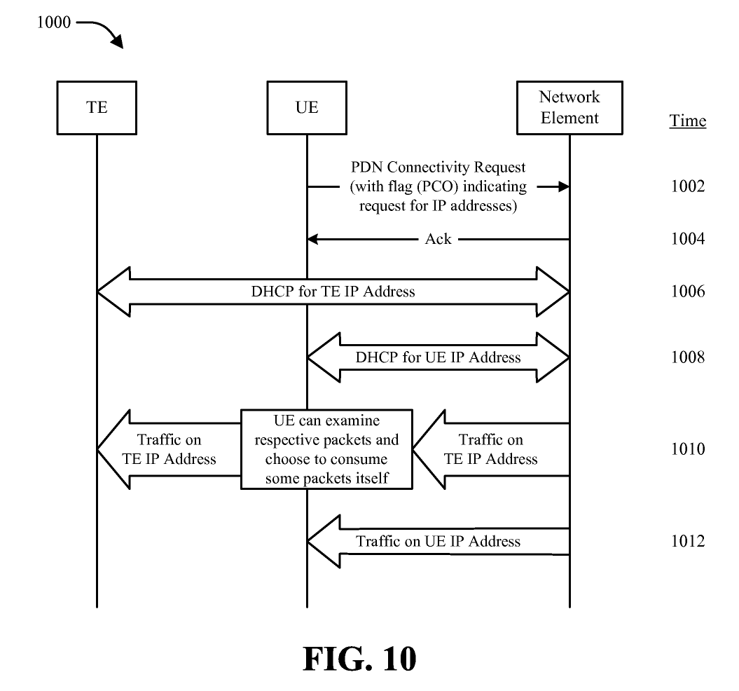

In accordance with another aspect, an example technique that can be employed to establish and utilize respective IP addresses for communication of packets associated with respective TFTs is illustrated by diagram 1000 in FIG. 10. As FIG. 10 illustrates, a UE can initially submit a PDN Connectivity Request message to an associated network element at time 1002 that specifies, for example, a flag (e.g., provided as or within a PCO option) that indicates a request for the establishment of respective IP addresses. This request can be acknowledged and/or otherwise accepted by the network element at time 1004, and subsequently DHCP can be initialized for IP addresses corresponding to a TE unit and the UE, respectively, at times 1006 and 1008. Upon establishment of DHCP at times 1006-1008, a network element can transmit packet traffic via the TE and UE IP addresses at times 1010 and 1012, respectively. As further shown in diagram 1000, the network element can be configured to transmit all traffic to the UE irrespective of IP address. Upon transmittal of packets by the network element, the UE can identify and distinguish traffic communicated via the TE IP address and/or the UE IP address and facilitate appropriate forwarding. In one example illustrated at time 1010, the UE can additionally be configured to examine respective packets determined to be destined for a TE device and determine whether to locally consume some or all of such packets in addition to or in place of external forwarding.

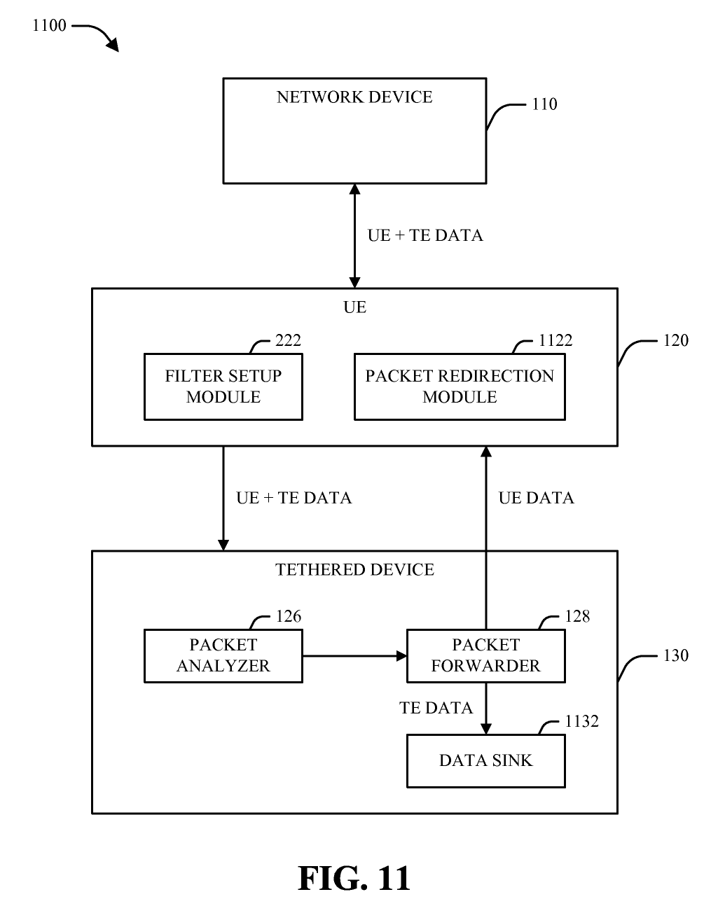

Turning to FIG. 11, a system 1100 for configuring a tethered device 130 for packet forwarding in accordance with various aspects is illustrated. As illustrated by system 1100, a UE 120 can utilize a filter setup module 222 to configure operation of a tethered device 130 such that all data packets communicated from an associated network device 110 are initially forwarded to the tethered device (e.g., via a packet redirection module 1122 at UE 120). For example, filter setup module 222 can be utilized to configure one or more TFT filters at tethered device 130 such that a packet analyzer 126 at tethered device 130 can apply the respective TFT filters to determine intended destinations of respective packets received from network device 110. Based on application of the filters, a packet forwarder 128 at tethered device 130 can be utilized to supply respective packets intended for an internal destination associated with tethered device 130 to a local data sink 1132 and/or to forward respective packets intended for an external destination associated with UE 120 back to UE 120. By initializing and employing filters in this manner, it can be appreciated that UE 120 can offload some or all packet analysis processing to one or more tethered devices 130 associated with UE 120, thereby saving processing overhead at UE 120.

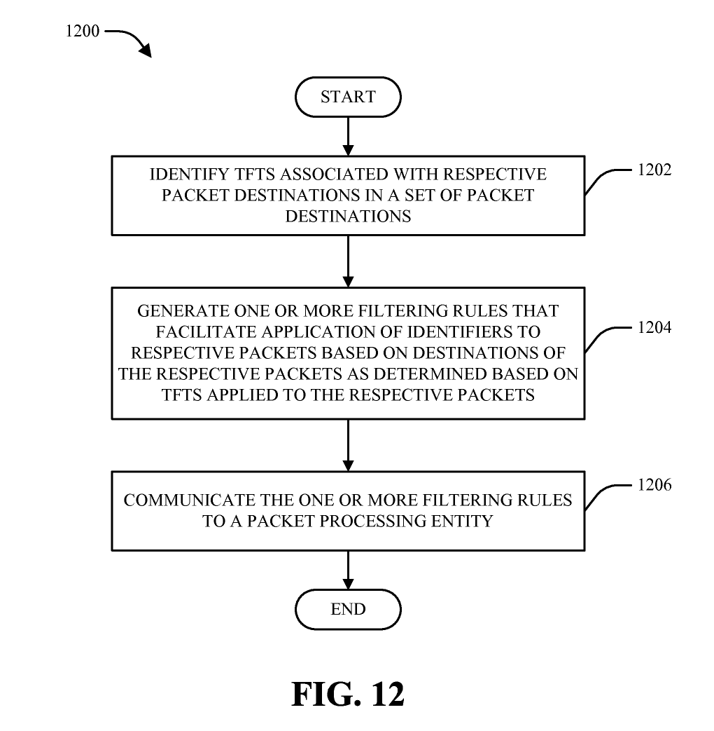

Referring now to FIGS. 12-16, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 12, illustrated is a methodology 1200 for configuring efficient packet differentiation and forwarding in a wireless communication system. It is to be appreciated that methodology 1200 can be performed by, for example, a UE (e.g., UE 120) and/or any other appropriate network device. Methodology 1200 begins at block 1202, wherein TFTs associated with respective packet destinations (e.g., internal destinations associated with UE 120 and/or external destinations associated with respective tethered devices 130) in a set of packet destinations are identified. Next, at block 1204, one or more filtering rules are generated (e.g., by a filter setup module 222) that facilitate application of identifiers (e.g., radio bearer IDs, logical channel IDs, IP addresses, etc.) to respective packets based on destinations of the respective packets as determined based on TFTs applied to the respective packets. Methodology 1200 can then conclude at block 1206, wherein the one or more filtering rules generated at block 1204 are communicated to a packet processing entity (e.g., a network device 110 and/or tethered device 130). In one example, filtering rules can be communicated at block 1206 within a PCO set provided during PDN context creation and/or in any other suitable manner.

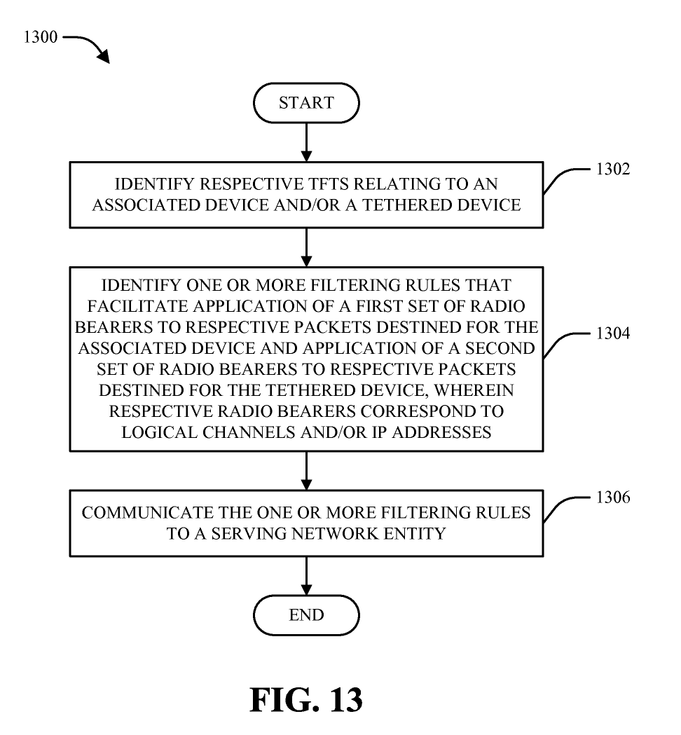

FIG. 13 illustrates another methodology 1300 for configuring efficient packet differentiation and forwarding in a wireless communication system. Methodology 1300 can be performed by, for example, a user device and/or any other suitable network device. Methodology 1300 begins at block 1302, wherein respective TFTs relating to a device associated with methodology 1300 and/or a tethered device are identified. Next, at block 1304, one or more filtering rules are identified that facilitate application of a first set of radio bearers to respective packets destined for the device associated with methodology 1300 and application of a second set of radio bearers to respective packets destined for the tethered device. In one example, the radio bearers utilized at block 1304 can correspond to logical channels, IP addresses, or the like. Further, the radio bearers utilized at block 1304 can include TE radio bearers associated with respective external packet destinations (e.g., corresponding to respective tethered devices), and/or UE radio bearers associated with respective internal packet destinations (e.g., corresponding to a device performing methodology 1300). Methodology 1300 can then conclude at block 1306, wherein the one or more filtering rules identified at block 1304 are communicated to a serving network entity.

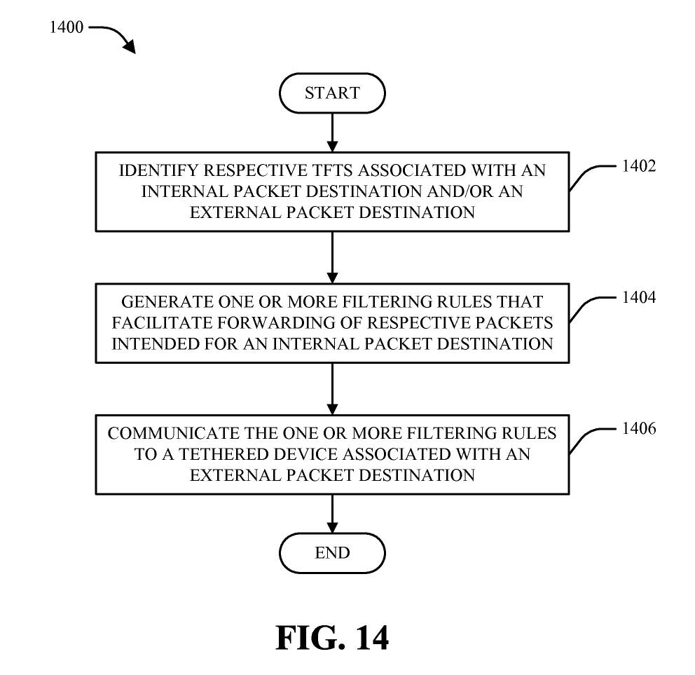

Referring to FIG. 14, illustrated is an additional methodology 1400 for configuring efficient packet differentiation and forwarding in a wireless communication system. It is to be appreciated that methodology 1400 can be performed by, for example, a mobile terminal and/or any other appropriate network device. Methodology 1400 begins at block 1402, wherein respective TFTs associated with an internal packet destination (e.g., corresponding to a UE 120 executing methodology 1400) and/or an external packet destination (e.g., corresponding to a tethered device 130) are identified. At block 1404, one or more filtering rules are generated that facilitate forwarding of respective packets intended for an internal packet destination (e.g., forwarding of packets from tethered device 130 to UE 120 via a packet analyzer 126 and/or packet forwarder 128 at tethered device 130). Finally, at block 1406, the one or more filtering rules generated at block 1404 can be communicated to a tethered device associated with an external packet destination identified at block 1402.

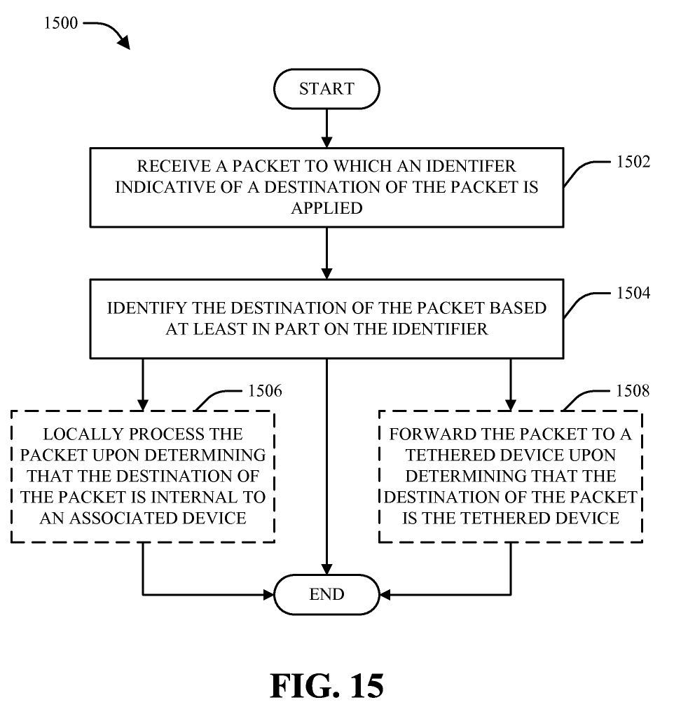

FIG. 15 illustrates a methodology for processing a received packet according to a preconfigured set of filtering rules. Methodology 1500 can be performed by, for example, a UE and/or any other appropriate network device. Methodology 1500 begins at block 1502, wherein a packet is received to which an identifier (e.g., bearer ID, logical channel ID, IP address, etc.) indicative of a destination of the packet is applied. By way of specific example, the identifier applied to the packet received at block 1502 can be an identifier for a UE radio bearer, a TE radio bearer, or the like, based on information relating to the identifier previously received. Thus, for example, information relating to a UE radio bearer can be obtained via a flag, a reserved QCI, and/or any other suitable indicator(s) provided within information received from a suitable packet processing entity.

Upon completing the acts described at block 1502, methodology 1500 can proceed to block 1504, wherein the destination of the packet received at block 1502 is identified based at least in part on the identifier applied thereto. In one example, in the event that the packet is received at block 1502 in connection with a default radio bearer associated with respective unidentified TFTs, analysis of the packet can be performed at block 1504 in order to determine the destination of the packet. In another example, upon identification of the destination of the packet, methodology 1500 can terminate. Alternatively, methodology 1500 can proceed to block 1506 prior to concluding, wherein the packet is locally processed upon determining that the destination of the packet is internal to a device associated with methodology 1500. As another alternative, methodology 1500 can proceed to block 1508 prior to concluding, wherein the packet is forwarded to a tethered device upon determining that the destination of the packet is the tethered device.

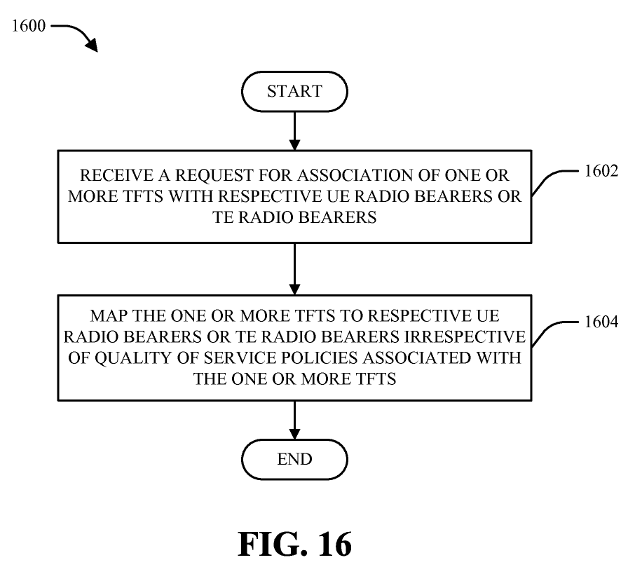

Turning to FIG. 16, a flow diagram of a methodology 1600 for establishing respective radio bearers for transmission of packets to multiple packet destinations is illustrated. Methodology 1600 can be performed by, for example, a base station (e.g., network device 110) and/or any other suitable network device. Methodology 1600 begins at block 1602, wherein a request for association of one or more TFTs with respective UE radio bearers or TE radio bearers is received. In one example, a request for TFT association can be received at block 1602 within a PCO set provided during PDN context creation and/or in any other suitable message(s). Further, respective UE radio bearers and/or TE radio bearers can correspond to respective logical channels, IP addresses, or the like.

Upon completing the acts described at block 1602, methodology 1600 can conclude at block 1604, wherein the one or more TFTs specified in the request received at block 1604 are mapped to respective UE radio bearers or TE radio bearers (e.g., by a filter configuration module 212) irrespective of QoS policies associated with the one or more TFTs. In one example, radio bearers to which TFTs are mapped at block 1604 can include newly created radio bearers, pre-existing radio bearers, or the like. Additionally or alternatively, upon mapping respective TFTs to radio bearers as described at block 1604, an entity performing methodology 1600 can transmit a response message that indicates respective UE radio bearers and/or TE radio bearers that have been mapped to the respective TFTs in accordance with various techniques as described herein. In accordance with one aspect, QoS-irrespective mapping of respective TFTs can be performed for substantially all TFTs utilized by an associated communication system or a predefined portion thereof (e.g., as defined by an allowable TFT list 214).

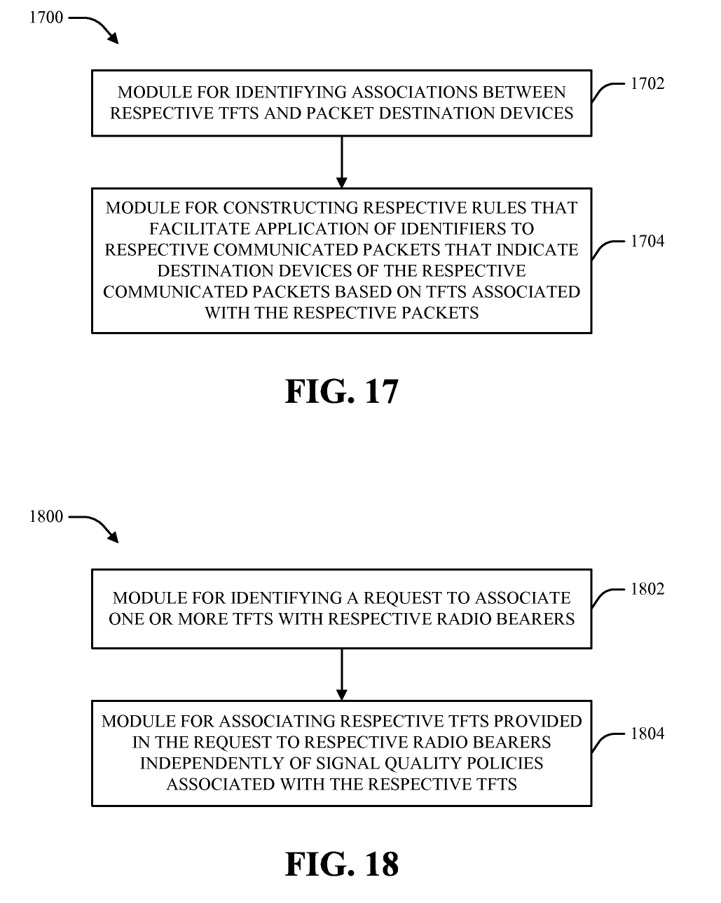

Referring next to FIGS. 17-18, respective apparatuses 1700-1800 that can be utilized to implement various aspects described herein are illustrated. It is to be appreciated that apparatuses 1700-1800 are represented as including functional blocks, which can be functional blocks that represent functions implemented by a processor, software, or combination thereof (e.g., firmware).

Turning first to FIG. 17, illustrated is an apparatus 1700 that facilitates packet differentiation and forwarding in a wireless communication system. Apparatus 1700 can be implemented by a UE (e.g., UE 120) and/or another suitable network entity and can include a module 1702 for identifying associations between respective TFTs and packet destination devices and a module 1704 for constructing respective rules that facilitate application of identifiers to respective communicated packets that indicate destination devices of the respective communicated packets based on TFTs associated with the respective packets.

FIG. 18 illustrates a second apparatus 1800 that facilitates packet differentiation and forwarding in a wireless communication system. Apparatus 1800 can be implemented by a network packet processing element (e.g., network device 110) and/or another suitable network entity and can include a module 1802 for identifying a request to associate one or more TFTs with respective radio bearers and a module 1804 for associating respective TFTs provided in the request to respective radio bearers independently of signal quality policies associated with the respective TFTs.

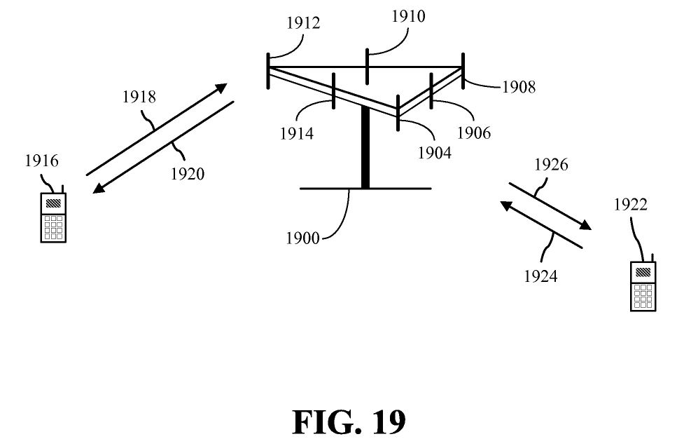

Referring now to FIG. 19, an illustration of a wireless multiple-access communication system is provided in accordance with various aspects. In one example, an access point 1900 (AP) includes multiple antenna groups. As illustrated in FIG. 19, one antenna group can include antennas 1904 and 1906, another can include antennas 1908 and 1910, and another can include antennas 1912 and 1914. While only two antennas are shown in FIG. 19 for each antenna group, it should be appreciated that more or fewer antennas may be utilized for each antenna group. In another example, an access terminal 1916 can be in communication with antennas 1912 and 1914, where antennas 1912 and 1914 transmit information to access terminal 1916 over forward link 1920 and receive information from access terminal 1916 over reverse link 1918. Additionally and/or alternatively, access terminal 1922 can be in communication with antennas 1906 and 1908, where antennas 1906 and 1908 transmit information to access terminal 1922 over forward link 1926 and receive information from access terminal 1922 over reverse link 1924. In a frequency division duplex system, communication links 1918, 1920, 1924 and 1926 can use different frequency for communication. For example, forward link 1920 may use a different frequency then that used by reverse link 1918.

Each group of antennas and/or the area in which they are designed to communicate can be referred to as a sector of the access point. In accordance with one aspect, antenna groups can be designed to communicate to access terminals in a sector of areas covered by access point 1900. In communication over forward links 1920 and 1926, the transmitting antennas of access point 1900 can utilize beamforming in order to improve the signal-to-noise ratio of forward links for the different access terminals 1919 and 1922. Also, an access point using beamforming to transmit to access terminals scattered randomly through its coverage causes less interference to access terminals in neighboring cells than an access point transmitting through a single antenna to all its access terminals.

An access point, e.g., access point 1900, can be a fixed station used for communicating with terminals and can also be referred to as a base station, an eNB, an access network, and/or other suitable terminology. In addition, an access terminal, e.g., an access terminal 1916 or 1922, can also be referred to as a mobile terminal, user equipment, a wireless communication device, a terminal, a wireless terminal, and/or other appropriate terminology.

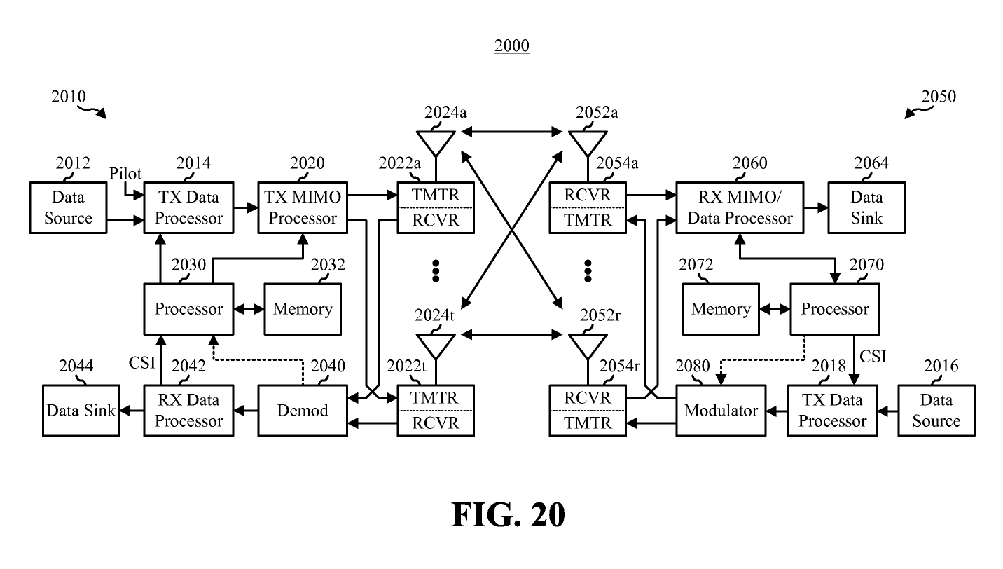

Referring now to FIG. 20, a block diagram illustrating an example wireless communication system 2000 in which various aspects described herein can function is provided. In one example, system 2000 is a multiple-input multiple-output (MIMO) system that includes a transmitter system 2010 and a receiver system 2050. It should be appreciated, however, that transmitter system 2010 and/or receiver system 2050 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 2010 and/or receiver system 2050 described herein could be utilized in connection with a single output to single input antenna system.

In accordance with one aspect, traffic data for a number of data streams are provided at transmitter system 2010 from a data source 2012 to a transmit (TX) data processor 2014. In one example, each data stream can then be transmitted via a respective transmit antenna 2024. Additionally, TX data processor 2014 can format, encode, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 2050 to estimate channel response. Back at transmitter system 2010, the multiplexed pilot and coded data for each data stream can be modulated (i.e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 2030.

Next, modulation symbols for all data streams can be provided to a TX processor 2020, which can further process the modulation symbols (e.g., for OFDM). TX MIMO processor 2020 can then provides N_{T} modulation symbol streams to N_{T} transceivers 2022a through 2022t. In one example, each transceiver 2022 can receive and process a respective symbol stream to provide one or more analog signals. Each transceiver 2022 can then further condition (e.g., amplify, filter, and upconvert) the analog signals to provide a modulated signal suitable for transmission over a MIMO channel. Accordingly, N_{T} modulated signals from transceivers 2022a through 2022t can then be transmitted from N_{T} antennas 2024a through 2024t, respectively.

In accordance with another aspect, the transmitted modulated signals can be received at receiver system 2050 by N_{R} antennas 2052a through 2052r. The received signal from each antenna 2052 can then be provided to respective transceivers 2054. In one example, each transceiver 2054 can condition (e.g., filter, amplify, and downconvert) a respective received signal, digitize the conditioned signal to provide samples, and then processes the samples to provide a corresponding “received” symbol stream. An RX MIMO/data processor 2060 can then receive and process the N_{R} received symbol streams from N_{R} transceivers 2054 based on a particular receiver processing technique to provide N_{T} “detected” symbol streams. In one example, each detected symbol stream can include symbols that are estimates of the modulation symbols transmitted for the corresponding data stream. RX processor 2060 can then process each symbol stream at least in part by demodulating, deinterleaving, and decoding each detected symbol stream to recover traffic data for a corresponding data stream. Thus, the processing by RX processor 2060 can be complementary to that performed by TX MIMO processor 2020 and TX data processor 2016 at transmitter system 2010. RX processor 2060 can additionally provide processed symbol streams to a data sink 2064.

In accordance with one aspect, the channel response estimate generated by RX processor 2060 can be used to perform space/time processing at the receiver, adjust power levels, change modulation rates or schemes, and/or other appropriate actions. Additionally, RX processor 2060 can further estimate channel characteristics such as, for example, signal-to-noise-and-interference ratios (SNRs) of the detected symbol streams. RX processor 2060 can then provide estimated channel characteristics to a processor 2070. In one example, RX processor 2060 and/or processor 2070 can further derive an estimate of the “operating” SNR for the system. Processor 2070 can then provide channel state information (CSI), which can comprise information regarding the communication link and/or the received data stream. This information can include, for example, the operating SNR. The CSI can then be processed by a TX data processor 2018, modulated by a modulator 2080, conditioned by transceivers 2054a through 2054r, and transmitted back to transmitter system 2010. In addition, a data source 2016 at receiver system 2050 can provide additional data to be processed by TX data processor 2018.

Back at transmitter system 2010, the modulated signals from receiver system 2050 can then be received by antennas 2024, conditioned by transceivers 2022, demodulated by a demodulator 2040, and processed by a RX data processor 2042 to recover the CSI reported by receiver system 2050. In one example, the reported CSI can then be provided to processor 2030 and used to determine data rates as well as coding and modulation schemes to be used for one or more data streams. The determined coding and modulation schemes can then be provided to transceivers 2022 for quantization and/or use in later transmissions to receiver system 2050. Additionally and/or alternatively, the reported CSI can be used by processor 2030 to generate various controls for TX data processor 2014 and TX MIMO processor 2020. In another example, CSI and/or other information processed by RX data processor 2042 can be provided to a data sink 2044.

In one example, processor 2030 at transmitter system 2010 and processor 2070 at receiver system 2050 direct operation at their respective systems. Additionally, memory 2032 at transmitter system 2010 and memory 2072 at receiver system 2050 can provide storage for program codes and data used by processors 2030 and 2070, respectively. Further, at receiver system 2050, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
identifying traffic flow templates (TFTs) associated with respective packet destinations in a set of packet destinations;
generating one or more filtering rules that facilitate application of identifiers to respective packets based on destinations of the respective packets as determined based on TFTs applied to the respective packets; and
communicating the one or more filtering rules to a packet processing entity.

2. The method of claim 1, wherein identifiers applied to respective packets relate to respective distinct radio bearers.

3. The method of claim 2, wherein the respective distinct radio bearers comprise one or more Terminal Equipment (TE) radio bearers associated with at least one external packet destination and one or more User Equipment (UE) radio bearers associated with at least one internal packet destination.

4. The method of claim 3, wherein the communicating comprises at least one of communicating a request for one or more UE radio bearers for communication of respective packets destined for the internal packet destination or communicating a request for one or more TE radio bearers for communication of respective packets destined for the external packet destination.

5. The method of claim 1, wherein the communicating comprises communicating the one or more filtering rules within a protocol configuration option (PCO) set provided during packet data network (PDN) context creation.

6. The method of claim 1, wherein identifiers applied to respective packets comprise respective distinct Internet Protocol (IP) addresses associated with respective packet destinations.

7. The method of claim 1, wherein:
the generating comprises generating one or more filtering rules that facilitate forwarding of respective packets intended for a predetermined packet destination; and
the communicating comprises communicating the one or more filtering rules to a tethered device.

8. The method of claim 7, wherein the predetermined packet destination is an internal packet destination.

9. The method of claim 7, wherein the predetermined packet destination is an external packet destination.

10. The method of claim 7, further comprising:
obtaining respective packets from a serving network element;
providing the respective packets to the tethered device; and
receiving at least one packet intended for the predetermined packet destination from the tethered device, wherein the at least one packet is forwarded by the tethered device according to the one or more filtering rules.

11. The method of claim 1, further comprising receiving information relating to identifiers applied to respective packets from the packet processing entity pursuant to the one or more filtering rules.

12. The method of claim 11, wherein the receiving comprises receiving information from the packet processing entity relating to an identifier associated with a UE radio bearer utilized for communication of respective packets destined for at least one internal packet destination.

13. The method of claim 12, wherein the UE radio bearer is identified as a UE radio bearer via at least one of a flag provided within the information received from the packet processing entity or a reserved quality of service (QoS) class indicator (QCI) provided within the information received from the packet processing entity.

14. The method of claim 11, further comprising:
receiving a packet having an identifier indicative of a destination of the packet applied thereto; and
identifying the destination of the packet based at least in part on the identifier applied to the packet.

15. The method of claim 14, further comprising forwarding the packet to a tethered device upon identifying that the destination of the packet is an external destination corresponding to the tethered device.

16. A wireless communications apparatus, comprising:
a memory that stores data relating to traffic flow templates (TFTs) associated with at least one of the wireless communications apparatus or one or more tethered devices; and
a processor configured to generate filtering rules that facilitate application of tags to respective packets based on destinations of the respective packets as determined based on TFTs associated with the respective packets and to communicate one or more filtering rules to a packet processing entity.

17. The wireless communications apparatus of claim 16, wherein tags applied to respective packets are configured to indicate respective distinct radio bearers.

18. The wireless communications apparatus of claim 17, wherein the processor is further configured to request initialization of one or more user equipment (UE) radio bearers for communication of respective packets destined for the wireless communications apparatus or to request initialization of one or more terminal equipment (TE) radio bearers for communication of respective packets destined for respective tethered devices.

19. The wireless communications apparatus of claim 16, wherein the processor is further configured to communicate one or more filtering rules within a protocol configuration option (PCO) set provided during packet data network (PDN) context creation.

20. The wireless communications apparatus of claim 16, wherein tags applied to respective packets are configured to indicate respective distinct Internet Protocol (IP) addresses.

21. The wireless communications apparatus of claim 16, wherein the packet processing entity is a tethered device and the filtering rules facilitate forwarding of respective packets destined for the wireless communications apparatus from the tethered device to the wireless communications apparatus.

22. The wireless communications apparatus of claim 16, wherein the processor is further configured to receive information relating to a tag applied to a UE radio bearer utilized for communication of respective packets destined for the wireless communications apparatus, the information comprising one or more of a flag parameter or a reserved quality of service (QoS) class indicator (QCI).

23. The wireless communications apparatus of claim 22, wherein the processor is further configured to receive a packet tagged with an intended destination of the packet and to identify the intended destination of the packet at least in part by analyzing a tag associated with the packet.

24. An apparatus, comprising:
means for identifying associations between respective traffic flow templates (TFTs) and a set of packet destination devices comprising the apparatus and at least one device tethered to the apparatus; and
means for constructing respective rules that facilitate application of identifiers to respective communicated packets that indicate destination devices of the respective communicated packets based on TFTs associated with the respective communicated packets.

25. The apparatus of claim 24, wherein identifiers applied to respective communicated packets are configured to indicate respective distinct radio bearers.

26. The apparatus of claim 25, wherein the means for constructing comprises one or more of the following:
means for constructing a request to a network associated with the apparatus for initialization of one or more user equipment (UE) bearers to be associated with respective packets destined for the apparatus; or
means for constructing a request to a network associated with the apparatus for initialization of one or more terminal equipment (TE) bearers to be associated with respective packets destined for at least one device tethered to the apparatus.

27. The apparatus of claim 24, wherein identifiers applied to respective communicated packets are configured to indicate respective distinct Internet Protocol (IP) addresses.

28. The apparatus of claim 24, wherein:
the means for constructing comprises means for constructing respective rules that facilitate forwarding of respective packets to the apparatus upon determining that the respective packets are destined for the apparatus; and
the apparatus further comprises means for communicating respective constructed rules to a device tethered to the apparatus, means for obtaining respective packets from a serving network element, means for providing the respective packets to the device tethered to the apparatus, and means for receiving at least one packet forwarded by the device tethered to the apparatus according to the respective constructed rules.

29. A computer program product, comprising:
a computer-readable medium, comprising:
code for causing a computer to identify associations between respective traffic flow templates (TFTs) and a set of packet destinations comprising a local device and at least one device tethered to the local device; and
code for causing a computer to construct respective rules that facilitate application of identifiers to respective communicated packets that indicate packet destinations respectively corresponding to the communicated packets based on TFTs associated with the respective communicated packets.

30. A method, comprising:
receiving a request for association of one or more traffic flow templates (TFTs) with respective user equipment (UE) radio bearers or terminal equipment (TE) radio bearers; and
mapping the one or more TFTs to respective UE radio bearers or TE radio bearers based on the request irrespective of quality of service (QoS) policies associated with the one or more TFTs.

31. The method of claim 30, wherein the mapping comprises mapping at least a portion of the one or more TFTs to existing UE radio bearers or TE radio bearers.

32. The method of claim 30, wherein the mapping comprises:
creating one or more new UE radio bearers or TE radio bearers; and
mapping at least a portion of the one or more TFTs to respective created UE radio bearers or TE radio bearers.

33. The method of claim 30, further comprising transmitting a response message that includes an indication of respective UE radio bearers or TE radio bearers mapped to the one or more TFTs.

34. The method of claim 33, wherein the transmitting comprises embedding a flag into the response message that identifies respective UE radio bearers as UE radio bearers.

35. The method of claim 33, wherein the transmitting comprises configuring the response message to convey a reserved QoS class indicator (QCI) that identifies respective UE radio bearers as UE radio bearers.

36. The method of claim 30, wherein the receiving comprises receiving the request within a protocol configuration option (PCO) set provided during packet data network (PDN) context creation.

37. The method of claim 30, wherein the mapping comprises:
identifying a predefined set of TFTs;
determining whether respective TFTs specified in the request are included in the predefined set of TFTs; and
mapping respective TFTs determined to be in the predefined set of TFTs to respective UE radio bearers or TE radio bearers based on the request irrespective of QoS policies associated with the respective TFTs.

38. The method of claim 30, further comprising:
identifying a packet to be transmitted;
identifying a TFT associated with the packet; and
transmitting the packet via a radio bearer associated with the identified TFT.

39. The method of claim 38, wherein:
the identifying a TFT comprises identifying a TFT not previously mapped to a UE radio bearer or a TE radio bearer; and
the transmitting comprises transmitting the packet via a default radio bearer.

40. The method of claim 30, further comprising communicating respective packets via one or more UE radio bearers or TE radio bearers according to a default set of QoS properties.

41. The method of claim 30, wherein respective UE radio bearers and TE radio bearers correspond to respective logical channels or Internet Protocol (IP) addresses.

42. A wireless communications apparatus, comprising:
a memory that stores data relating to one or more traffic flow templates (TFTs) requested for association with respective user equipment (UE) radio bearers or terminal equipment (TE) radio bearers; and
a processor configured to map the one or more TFTs to respective UE radio bearers or TE radio bearers irrespective of quality of service (QoS) policies associated with the one or more TFTs.

43. The wireless communications apparatus of claim 42, wherein the processor is further configured to transmit a message comprising an indication of respective UE radio bearers or TE radio bearers mapped to the one or more TFTs, the indication comprising at least one of a flag or a reserved QoS class indicator (QCI) embedded into the message.

44. The wireless communications apparatus of claim 42, wherein the processor is further configured to identifying a predefined set of allowable TFTs, to determine whether respective TFTs requested for association with respective UE radio bearers or TE radio bearers are included in the predefined set of allowable TFTs, and to perform mapping for respective TFTs determined to be included in the predefined set of allowable TFTs irrespective of QoS policies associated with the respective TFTs.

45. The wireless communications apparatus of claim 42, wherein the processor is further configured to identify a packet to be transmitted, to identify a TFT associated with the packet, and to transmit the packet via a radio bearer associated with the identified TFT.

46. The wireless communications apparatus of claim 42, wherein respective UE radio bearers or TE radio bearers correspond to at least one of logical channels or Internet Protocol (IP) addresses.

47. An apparatus, comprising:
means for identifying a request to associate one or more traffic flow templates (TFTs) with respective radio bearers; and
means for associating respective TFTs provided in the request to respective radio bearers independently of signal quality policies associated with the respective TFTs.

48. The apparatus of claim 47, wherein:
the respective radio bearers comprise at least one of a user equipment (UE) radio bearer or a terminal equipment (TE) radio bearer; and
the apparatus further comprises means for transmitting information indicative of respective UE radio bearers or TE radio bearers associated with the one or more TFTs, the information comprising at least one of a flag parameter or a reserved quality of service (QoS) class indicator (QCI).

49. The apparatus of claim 47, wherein the means for associating comprises:
means for identifying a set of allowable TFTs;
means for determining whether respective TFTs specified in the request are included in the set of allowable TFTs; and
means for mapping respective TFTs determined to be included in the set of allowable TFTs independently of signal quality policies associated with the respective TFTs.

50. A computer program product, comprising:
a computer-readable medium, comprising:
code for causing a computer to identify a request to associate one or more traffic flow templates (TFTs) with respective radio bearers; and
code for causing a computer to associate respective TFTs provided in the request to respective radio bearers irrespective of signal quality policies associated with the respective TFTs.
